(19) United States
(12) Patent Application Publication
(10) Pub. No.: US 2007/0074078 A1
(43) Pub. Date: Mar. 29, 2007

(54) Test replication through revision control linking

(76) Inventor: Matthew P. Potts, Citrus Heights, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/233,856

(22) Filed: Sep. 23, 2005

(51) Int. Cl. G06F 11/00

(52) U.S. Cl. 714/38

(57) ABSTRACT

In one embodiment, a method for test replication through revision control linking, the method comprising: checking out a test case; viewing a corresponding V file that has the contents of the test case, wherein the corresponding V file is linked to the test case; modifying the contents in the V file; and checking in the modified V file with a modified V file name, so that the modified V file is stored. In another embodiment, an apparatus for test replication through revision control linking, includes various features that can perform the above method.

### TECHNICAL FIELD

Embodiments of the invention relate generally to testing methods or simulation methods in a test environment, and more particularly to an apparatus and method for test replication or test modification through revision control linking.

### BACKGROUND

Testing of the designs of electronics devices such as, for example, network switches or other devices, are performed in order to verify the functionalities of the designs and to detect for possible defects in the designs. As known to those skilled in the art, test cases are used for testing of the design. A test case is implemented by software code and provides one or more sets of stimulus that is driven into a design-under-test (DUT) so that the design-under-test is tested for correct functionalities and possible defects.

Conventional approaches in the writing of tests for designs suffer from the following disadvantages. First, previous methods could not maintain the tests cases in synchronization (updated) for purposes of proper debugging and also could not permit modifications of the test cases individually for debugging. Second, previous methods can detect when some test cases have changed, but could not detect the differences and would not update the related test files.

The previous methods involved manually copying the test files, and this method resulted in test files that were out of sync. For example, a user may have selected a test file that has been updated or may have selected a test file with non-updated code. The user has no way of knowing if the test file has non-updated code.

In previous methods, manually linking the test files may potentially avoid the problem of test files being out of sync. However, the manual linking of the test files does not allow the individual test files to be changed for use in debugging.

Therefore, the current technology is limited in its capabilities and suffers from at least the above constraints and deficiencies.

### SUMMARY OF EMBODIMENTS OF THE INVENTION

In one embodiment of the invention, a method for test replication through revision control linking, the method comprising: checking out a test case; viewing a corresponding V file that has the contents of the test case, wherein the corresponding V file is linked to the test case; modifying the contents in the V file; and checking in the modified V file with a modified V file name, so that the modified V file is stored.

In another embodiment, an apparatus for test replication through revision control linking, includes: a device configured to store at least one test case and a corresponding V file; a checkout/check-in engine configured to check out the test case and for viewing the corresponding V file that has the contents of the test case, wherein the corresponding V file is linked to the test case; and a modifying engine configured to modify the contents in the V file, wherein the checkout/check-in engine is also configured to check in the modified V file with a modified V file name, so that the modified V file is stored.

Therefore, in an embodiment of the invention, when a user re-checks out a test file, the test file would be automatically synched up so that the test file is automatically updated. Therefore, an embodiment of the invention provides a method of automatically updating tests together, whether the updates are to the features, test files, etc. Second, test files can now be individually changed for debugging and then recovered and resynched from the revision control file.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a system (apparatus), in accordance with an embodiment of the invention.

FIG. 2 is a block diagram that illustrates additional details of a test replication through revision control linking as performed by the system of FIG. 1, in accordance with an embodiment of the invention.

FIG. 3 is a flowchart of a method, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

An embodiment of the invention provides various advantages. First, when a user re-checks out a test file, the test file would be automatically synched up so that the test file is automatically updated. Therefore, an embodiment of the invention provides a method of automatically updating tests together, whether the updates are to the features, test files, etc. Second, test files can now be individually changed for debugging and then recovered and resynched from the revision control file. Another advantage of an embodiment of the invention is that the test case files is a very efficient method of storing sets of stimulus in order to save a large amount of disk space.

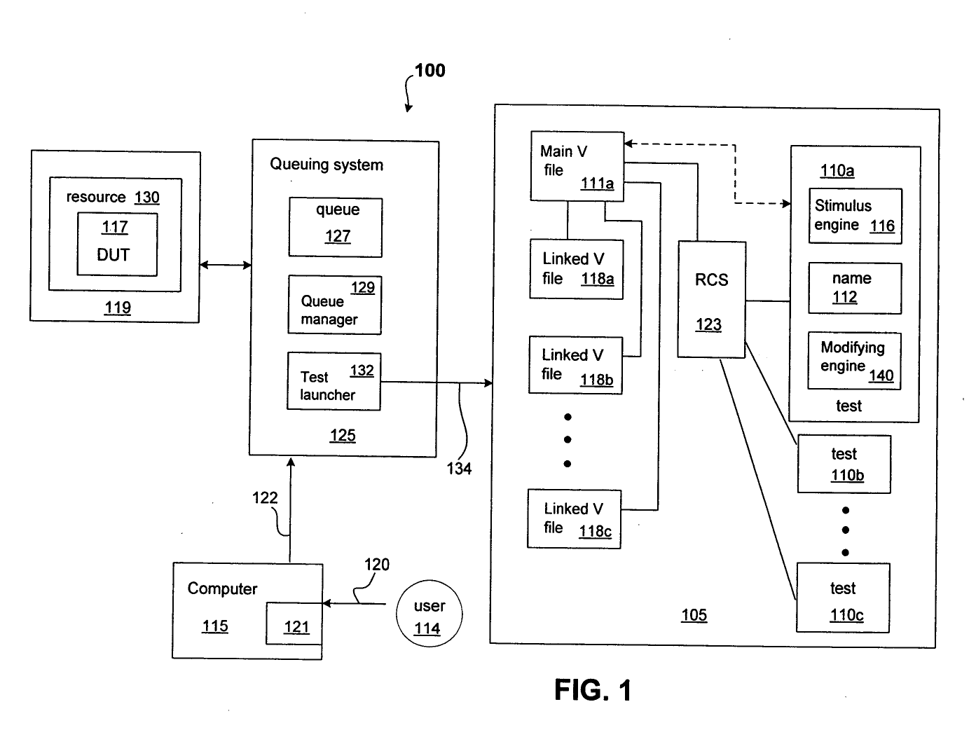

FIG. 1 is a block diagram of a system (apparatus) 100 that can use a test case (generally, test 110), in accordance with an embodiment of the invention. The system 100 includes a device 105 which may be, for example, a storage device, a computing device, or another suitable device that can store one or more test case 110. A test case 110 is written in a suitable programming language such as, for example, the PERL script programming language or other suitable programming language. Each test case 110 corresponds to a file, and is implemented as a software code that provides stimulus for testing one or more design-under-test (DUT) 117 in a test environment 119. For example, the test case 110 is written in a specific programming language such as the PERL script programming language or other suitable programming languages.

A test case 110 (e.g., test case 110a) includes one or more stimulus engine 116 that provides stimulus to be driven into a design-under-test (DUT) 117 in the test environment 119, so that testing is performed on the DUT 117 for proper functionalities and possible defects. Typically, a test case 110 (e.g., test case 110a) will contain one or more stimulus engine 116, although only one stimulus engine 116 is shown in the example of FIG. 1.

The user 114 will use the computer 115 in order to select one or more test case 110 for testing one or more designs-under-test 117 in the test environment 119. It is noted that other users in the system 100 can use other computers (not shown in FIG. 1) in order to select one or more test cases 110 for testing one or more designs-under-test 117 in the test environment 119. Also, in the example of FIG. 1, the design-under-test 117 is shown as only being present in a resource 130. However, the design-under-test 117 may be present in other resources in the test environment 119. Additionally, more than one design-under-test 117 may be present in the test environment 119.

The test case 110 has a test name 112. This test name 112 is known to the user 114 of a computer 115. For example, the test name 112 of the test case 110a is “[NCPU]_{—}1518U_MODEF.TC”, although other suitable test names may be used in other examples or if the test case 110 provides a different stimulus for testing a design-under-test. If the test name 112 is “[NCPU]_{—}1518U_MODEF.TC, then the test 110a provides a stimulus engine 116 that generates packets that are 1518 bytes in size. The test name 112 will differ if the test case 110a provides a different stimulus.

The user 114 selects a test case 110 for testing the design-under-test 117. The user 114 selects a test case 110 by providing a command 120 that is received and processed by a user interface 121 of the computer 115. The computer 115 sends a command 122 to a queuing system 125, and in response to the command 122, the queuing system 125 will obtain and place into a queue 127 the selected test case 110. The queuing system 125 is typically implemented by a suitable computing device such as, for example, a server or another suitable type of computing device. The queue 127 may be, for example, a memory storage space or a memory buffer. Note that the user 114 and/or other users can select additional test cases for testing the DUT 117.

The queuing system 125 will then distribute the queued test case 110 to one or more resource 130 in the test environment 119. For example, the resource 130 is a computer that is used for testing a design-under-test 117. The number of resources 130 in the test environment 119 may vary.

The queuing system 125 includes a queue manager 129 which is software that will queue the jobs (i.e., distributed test cases) to be run on the resource 130 in order to test a design-under-test 117. The queue manager 129 manages the resource 130 that will run the test cases 110 so that the DUT 117 is tested. The queue manager 129 can be any suitable commercially available queue manager. Further details on the queuing of test cases for testing a DUT is described in, for example, commonly-assigned U.S. patent application Ser. No. 11/084,765, entitled “APPARATUS AND METHOD FOR DETECTING IF A TEST IS RUNNING”, by Matthew P. Potts. U.S. patent application Ser. No. 11/084,765 is hereby fully incorporated herein by reference.

The queuing system 125 includes a test launcher 132 is in communication with the queue manager 129, so that the test launcher 132 can grab a test case 110 from the device 105 and the queue manager 129 can the distribute the test case 110 to the resource 130 so that the test case 110 is used for simulating the DUT 117. In an alternative embodiment of the invention, the functionalities of the test launcher 132 are implemented by each test case 110 so that the launcher 132 is not required to be implemented in the queuing system 125. In this alternative embodiment, the launcher 132 would be implemented as part of the test case 110.

The test launcher 132 can read the name 112 of the test 110 and can provide a variable 134 which is then fed back to a modifying engine 140 of the test case 110. The feedback variable 134 indicates the test name 112 that is read by the test launcher 132. For example, if the test name 112 is [NCPU]_{—}1518U_MODEF.TC, then the test launcher 132 can read this test name 112 and send a feedback variable 134 that indicates the test name 112. As mentioned above, the term “1518” in the test name 112 indicates that the stimulus 116 provides test packets that are 1518 bytes in size. The term “.TC” indicates that the test name 112 is for a test case file. The term “1518U_MODEF” indicates that the name of the test case 112 itself. If the term “1518U_MODEF” were changed to “64U_MODEF” in the test name 112, then the test name 112 of “[NCPU]_{—}1518U_MODEF.TC” will change to the modified test name of “[NCPU]_{—}64U_MODEF.TC”. The test launcher 132 will read this modified test name and will then send back a feedback variable 134 that indicates the “64U” value in the modified test name. Based on the “64U” value in the feedback variable 134, the modifying engine 140 will modify the test case 110 so that the stimulus engine 116 will now generate a new stimulus 160 of test packets that will be 64 bytes in size, instead generating the previous stimulus 162 of test packets that are 1518 bytes in size. The stimulus engine 112 will modify the code in the stimulus engine 116a by parsing the code in the stimulus engine 116 and modifying the code strings for generating the packet size. If the test case 110a is implemented in the PERL programming language or other programming language, then the modifying engine 140 will be a code that performs regular expression matching by selecting strings in the code in the stimulus engine 116a. As known to those skilled in the art, regular expression matching is method for searching for a series of digits and strings in a code. The modifying engine 140 will then replace the selected strings with the feedback variable 134 related to the new test name 112a. For example, the modifying engine 140 will parse the code in the stimulus engine 116a and replace each variable 1518u in the code with the variable 64u, so that the stimulus is changed to a different packet size. This method of permitting the user 114 to create a new test or modify a test case 110 by changing the name 112 of the test case 110 into a modified test name is described in additional details in commonly-assigned U.S. commonly-assigned U.S. patent application Ser. No. 11/______, entitled “TEST REPLICATION THROUGH RENAMING”, by Matthew P. Potts and Steven Jorgensen, filed on Sep. 21, 2005, which is hereby fully incorporated herein by reference. However, it is noted that a test case 110 may also be modified by other methods such as, for example, manual programming in order to modify the code in the test case 110.

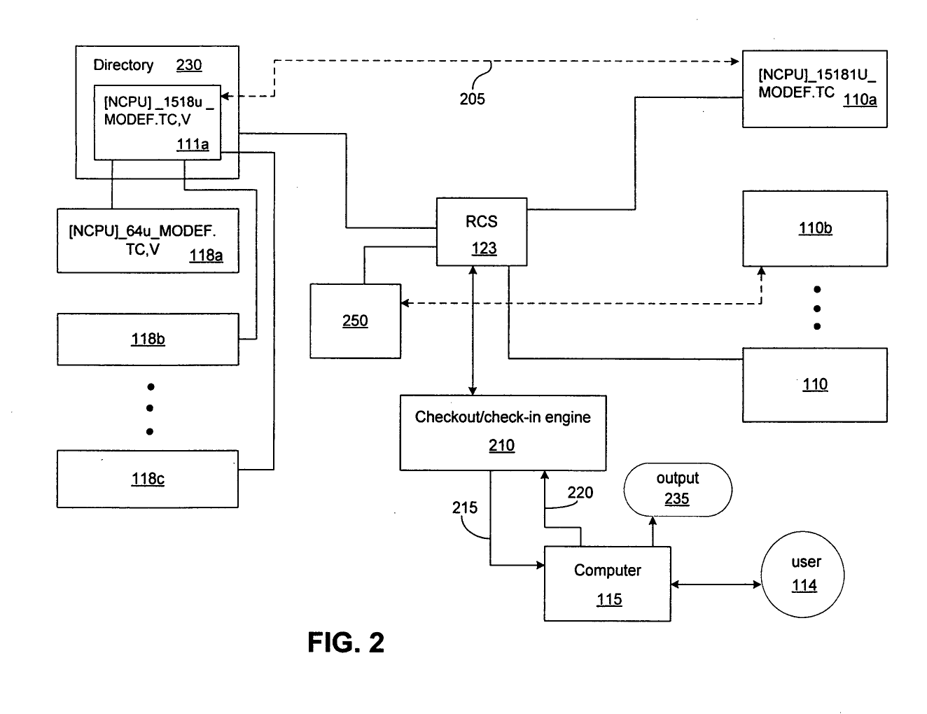

In an embodiment of the invention, a revision control system 123 is used to perform replication of a test 110 through revision control linking. Each test 110 will have a corresponding revision control system (RCS) main file (i.e., “main V file”). In the example of FIG. 1, the test 110a has a corresponding RCS main file 111a. The RCS main file 111a has one or more RCS linked files (i.e., “linked V files” 118a-118c). The functions of the revision control system 123 are described in further detail below with reference to FIG. 2.

The system 100 also typically includes other components that are known and are used for permitting functions and data transmission in a network. For example, each computing device (e.g., resources 130, queuing system 125, and user computer 115) includes a processor (e.g., central processing unit) for executing software or firmware in the computing device. For purposes of focusing on the embodiments of the invention, these other known components are not shown in FIG. 1 and are not necessarily described herein.

FIG. 2 is a block diagram that illustrates additional details of a test replication through revision control linking as performed by the system of FIG. 1, in accordance with an embodiment of the invention. The revision control system 123 manages multiple revisions of source codes for the tests 110 as discussed in detail below. The revision control system 123 automates the storing, retrieval, logging, identification, and merging of revisions of the test source codes. The revision control system 123 can store the revisions with the aid of, for example, the Diff utility which outputs the differences between two text files.

In the example of FIG. 2, assume that the test case 110a has the test name [NCPU]_{—}1518u_MODEF.TC, although the test case 110a can have other test names in other examples or if the test case 110a performs a different function than the function discussed above. The revision control system 123 manages the test case 110a. The revision control system 123 may also manage additional tests (e.g., test cases 110b and 100c, and/or other test cases).

The revision control system 123 links 205 the test case [NCPU]_{—}1518u_MODEF.TC to the corresponding RCS main file 111a (V file 111a). A link 205 can link to any file or directory, using UNC (Uniform Naming Convention) paths. A link to an executable file can pass arguments and specify the directory in which the command should run. In a WINDOWS based system, a link is also referred to as a “shortcut”.

In the example of FIG. 2, the RCS main file 111a would have a test name of [NCPU]_{—}1518u_MODEF.TC,V, where “TC,V” is a naming convention in RCS to indicate that the RCS main file [NCPU]_{—}1518u_MODEF.TC,V is linked in RCS to the test file [NCPU]_{—}1518u_MODEF.TC. When the user 114 selects or points to the V file [NCPU]_{—}1518u_MODEF.TC,V, the link 205 would display the contents in the linked test file [NCPU]_{—}1518u_MODEF.TC. As known to those skilled in the art, other types of revision control systems that are not based on RCS does not necessarily use the “TC,V” naming convention, and therefore, other naming conventions can be used for the revision control linking.

The user 114 can use the computer 115 to communicate with a checkout/check-in engine 210 so that the user 114 can checkout 215 (or check-in 220) the test file [NCPU]_{—}1518u_MODEF.TC, or checkout/check-in any other test file (e.g., test files 110b and/or 110c). The checkout/check-in engine 210 can be, for example, a script application that performs the checkout and check-in functions for a file.

As an example, assume that the user 114 checks out 215 the test file [NCPU]_{—}1518u_MODEF.TC. The revision control system 123 will enable the user 114 to view the V file [NCPU]_{—}1518u_MODEF.TC,V which will be a copy of the linked test file [NCPU]_{—}1518u_MODEF.TC. The user 114 can then modify the V file [NCPU]_{—}1518u_MODEF.TC,V so that the stimulus or feature of the V file [NCPU]_{—}1518u_MODEF.TC,V is changed. For example, the user 114 can modify the V file [NCPU]_{—}1518u_MODEF.TC,V by changing the V file name to the modified V file name [NCPU]_{—}64u_MODEF.TC,V or any other V file name. By changing the V file name, the code in the V file is changed by the modifying engine 140 as previously described in the method above for changing a test name in order to change a test. Alternatively, the user 114 can modify the V file [NCPU]_{—}1518u_MODEF.TC,V by manually changing the code of the V file, although this method is less preferrable. Assume in this example that the V file name [NCPU]_{—}1518u_MODEF.TC,V was changed to the modified V file name [NCPU]_{—}64u_MODEF.TC,V. When the user checks-in 220 the V file [NCPU]_{—}64u_MODEF.TC,V, the revision control system 123 will store the V file [NCPU]_{—}64u_MODEF.TC,V in, for example, the file 118a.

If the user 114 makes other types of modifications to the V file [NCPU]_{—}64u_MODEF.TC,V, then the revision control system 123 can store the other modified V files in other files (e.g., file 118b or file 118c). Therefore, the user 114 can see the different revisions to the test file [NCPU]_{—}1518u_MODEF.TC, at different points in time by checking out and viewing and/or running the V files 118a, 118b, or/and 118c. For example, the user 114 can view the V files via output 235 of computer 115. The output 235 can be, for example, a display of text and/or images on a screen of computer 115, a paper printout that is enabled by the computer 115, or other types of output that permits the user 114 to view the contents of the V files.

Alternatively, the user 114 can check out 215 the test file NCPU]_{—}1518u_MODEF.TC and then modify the linked V file [NCPU]_{—}1518u_MODEF.TC,V so that the stimulus or feature of the V file [NCPU]_{—}1518u_MODEF.TC,V is changed or so that the user can debug the V file [NCPU]_{—}1518u_MODEF.TC,V. The user can then run the modified V file (e.g., [NCPU]_{—}64u_MODEF.TC,V) but not check in 220 this modified V file. As a result, the user 114 can perform debugging of a test file by modifying the linked V file, but is not required to store the modified V file in the RCS managed system.

A further advantage of the RCS managed system in FIG. 2 is that the user 114 can check out 215 any of the V files 118a-118c, even if another user has currently checked out one of the V files 118a-118c. As a result, the user 114 is prevented from checking out a stale copy of the V files 118a-118c and will obtain the latest updated copy of any of the V files 118a-118c.

All V files that are linked to the main V file [NCPU]_{—}1518u_MODEF.TC,V are typically stored in the same directory 230 in the device 105. Therefore, the V files 111a and 118a-118c are all in the same directory 230. The V files 118a-118c can be linked to the main V file 111a by revision control linking which is a function performed by the revision control system 123.

The test case 110b may also have a corresponding RCS main file (V file) 250, which permits the user 114 to view the contents and revisions in the test case 110b by viewing the main V file 250 and modifications of the main V file 250. The user can also save revisions to the contents in the test case 110b in modified V files, as similarly described above.

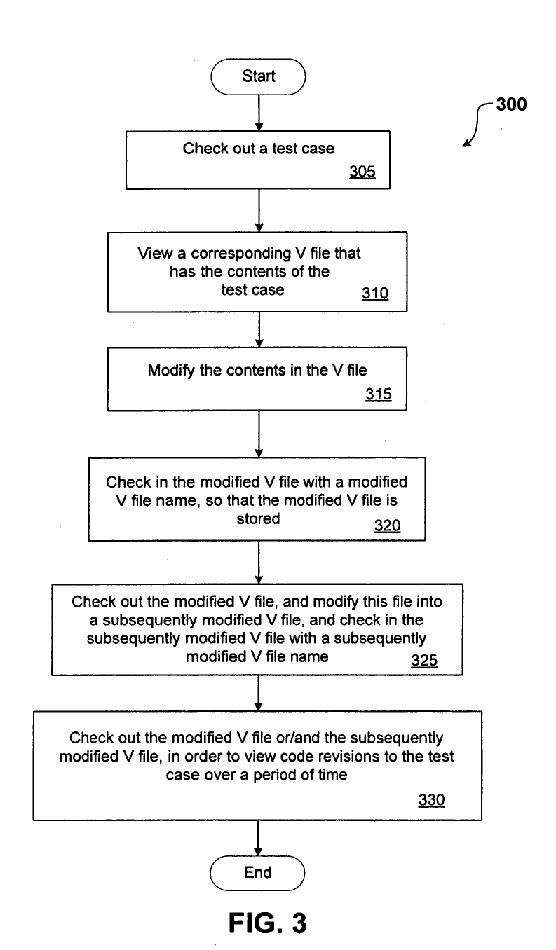

FIG. 3 is a flowchart of a method 300, in accordance with an embodiment of the invention. In block 305, a user checks out a test case. In block 310, a corresponding V file is viewed, where the corresponding V file has the contents of the test case. The corresponding V file is linked to the test case. In block 315, the user modifies the contents of the V file. For example, the user can modify the contents of the V file by changing the V file name to a modified V file name. In block 320, the user checks in the modified V file with a modified V file name, and this result in the modified V file to be stored.

In block 325, the user may check out the modified V file and may modify the modified V file into a subsequently modified V file, and then check in the subsequently modified V file with a subsequently modified V file name, so that the subsequently modified V file is stored.

In block 330, the user may check out the modified V file, and/or the subsequently modified V file, and/or any other stored modified V files, in order to view code revisions to the test case over a period of time.

Various elements in the drawings may be implemented in hardware, software, firmware, or a combination thereof.

The various engines or codes discussed herein may be, for example, computer software, firmware, commands, data files, programs, code, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of an embodiment of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

It is also noted that the various functions, variables, or other parameters shown in the drawings and discussed in the text have been given particular names (e.g., “revision control system” or the like) for purposes of identification. However, the function names, variable names, or other parameter names are only provided as some possible examples to identify the functions, variables, or other parameters. Other function names, variable names, or parameter names may be used to identify the functions, variables, or parameters shown in the drawings and discussed in the text.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for test replication through revision control linking, the method comprising:
checking out a test case;
viewing a corresponding V file that has the contents of the test case, wherein the corresponding V file is linked to the test case;
modifying the contents in the V file; and
checking in the modified V file with a modified V file name, so that the modified V file is stored.

2. The method of claim 1, further comprising:
modifying the modified V file into a subsequently modified V file; and
checking in the subsequently modified V file with a subsequently modified V file name, so that the subsequently modified V file is stored.

3. The method of claim 1, further comprising:
checking out any modified V file that has been stored, in order to view code revisions to the test case over a period of time.

4. The method of claim 1, further comprising:
after modifying the contents in the V file to debug the V file, then avoiding in checking in the modified V file to prevent storage of the modified V file.

5. The method of claim 1, wherein the test case is linked to the corresponding V file by use of revision control linking.

6. The method of claim 1, wherein the V file and the modified V file is stored in the same directory.

7. The method of claim 1, wherein modifying the contents in the V file comprises:
modifying a file name of the V file in order to modify the contents.

8. The method of claim 1, wherein modifying the contents in the V file comprises:
modifying a code in the V file by manual programming.

9. An apparatus for test replication through revision control linking, the apparatus comprising:
a device configured to store at least one test case and a corresponding V file;
a checkout/check-in engine configured to check out the test case and for viewing the corresponding V file that has the contents of the test case, wherein the corresponding V file is linked to the test case; and
a modifying engine configured to modify the contents in the V file, wherein the checkout/check-in engine is also configured to check in the modified V file with a modified V file name, so that the modified V file is stored.

10. The apparatus of claim 9, wherein the modifying engine is configured to modify the modified V file into a subsequently modified V file, and wherein the checkout/check-in engine is configured to check in the subsequently modified V file with a subsequently modified V file name, so that the subsequently modified V file is stored.

11. The apparatus of claim 9, wherein the checkout/check-in engine is configured to check out any modified V file that has been stored, in order to permit viewing of code revisions to the test case over a period of time.

12. The apparatus of claim 9, wherein the modified V file is not stored after modifying the contents in the V file to debug the V file, in order to prevent storage of the modified V file.

13. The apparatus of claim 9, wherein the test case is linked to the corresponding V file by use of revision control linking.

14. The apparatus of claim 9, wherein the V file and the modified V file is stored in the same directory.

15. The apparatus of claim 9, wherein the modifying engine modifying engine modifies the contents in the V file if a file name of the V file is modified.

16. The apparatus of claim 9, wherein the contents in the V file is modified by modifying a code in the V file by manual programming.

17. An apparatus for test replication through revision control linking, the apparatus comprising:
means for checking out a test case;
means for viewing a corresponding V file that has the contents of the test case, wherein the corresponding V file is linked to the test case;
means for modifying the contents in the V file; and
means for checking in the modified V file with a modified V file name, so that the modified V file is stored.

18. An article of manufacture, comprising:
a machine-readable medium having stored thereon instructions to:
check out a test case;
view a corresponding V file that has the contents of the test case, wherein the corresponding V file is linked to the test case;
modify the contents in the V file; and
check in the modified V file with a modified V file name, so that the modified V file is stored.
